(19) United States
(12) Patent Application Publication
(10) Pub. No.: US 2016/0102229 A1
(43) Pub. Date: Apr. 14, 2016

(54) OPTICAL FILM WITH PRESSURE SENSITIVE ADHESIVE AND PRODUCTION METHOD THEREOF, AND METHOD FOR PRODUCING IMAGE DISPLAY DEVICE

(71) Applicant: NITTO DENKO CORPORATION, Osaka (JP)

(72) Inventors: Shou TAKARADA, Osaka (JP); Masaki MIZUTANI, Osaka (JP); Atsushi YASUI, Osaka (JP)

(73) Assignee: NITTO DENKO CORPORATION, Osaka (JP)

(21) Appl. No.: 14/876,948

(22) Filed: Oct. 7, 2015

(30) Foreign Application Priority Data
Oct. 10, 2014 (JP) 2014-209468

(51) Int. Cl. C09J 7/02; B32B 37/12; B32B 37/14; C09J 133/08

(52) U.S. Cl. CPC C09J 7/0217; C09J 133/08; B32B 37/12; B32B 37/14; C09J 2433/00; B32B 2307/42; B32B 2457/20; B32B 2405/00

(57) ABSTRACT

The optical film with a pressure sensitive adhesive comprises an optical film including a polarizing plate, a first pressure sensitive adhesive layer provided on first main surface of the optical film, and a second pressure sensitive adhesive layer provided on second main surface of the optical film. The first pressure sensitive adhesive layer has a thickness of 30 μm or more. In the first pressure sensitive adhesive layer, a fluidity of a pressure sensitive adhesive at an end surface is lower than a fluidity of the pressure sensitive adhesive at an in-plane central part.

### TECHNICAL FIELD

The present invention relates to an optical film with a pressure sensitive adhesive, which is used for formation of an image display device including a transparent plate, a touch panel, or the like on the front surface of an image display panel, and relates to a production method of the optical film with a pressure sensitive adhesive. The present invention also relates to a method for producing an image display device using the optical film with a pressure sensitive adhesive.

### BACKGROUND ART

Liquid crystal displays and organic EL displays are widely used as various kinds of image display devices of mobile phones, car navigation devices, personal computer monitors, televisions and so on. On a viewing side outermost surface of an image display panel (a liquid crystal panel or an organic EL panel), a front transparent plate (also referred to as a “window layer” etc.) such as a transparent resin plate or a glass plate may be provided, for the purpose of, for example, preventing damage to the image display panel due to impact from the outer surface.

For arranging a front transparent plate on a front surface of an image display panel (e.g., liquid crystal panel and organic EL panel), an “interlayer filling structure” is employed in which the front transparent plate and the image display panel are bonded with a pressure sensitive adhesive layer therebetween. In the interlayer filling structure, a gap between the panel and the front transparent plate is filled with a pressure sensitive adhesive to decrease a refractive index difference at the interface, and therefore deterioration of visibility due to reflection and scattering is suppressed. There has been proposed a film with a pressure sensitive adhesive on both sides, which includes an optical film such as a polarizing plate, one surface of which is provided with a pressure sensitive adhesive layer for bonding the film to an image display panel and the other surface of which is provided with an interlayer filling pressure sensitive adhesive for bonding the film to a front transparent plate (e.g., JP-A-2012-237965 and JP-A-2014-115468).

A colored layer (decorative printed layer) intended for decoration and light shielding is formed at the peripheral edge of the front transparent plate on the panel side surface. When the decorative printed layer is formed at the peripheral edge of the transparent plate, a printing level difference of about 10 μm to several tens μm is generated. When a sheet pressure sensitive adhesive is used as an interlayer filler, bubbles are easily generated on the periphery of the printing level difference portion. Display unevenness may occur at the periphery edge of a screen because local stress is added to the image display panel immediately below the printing level difference portion through the pressure sensitive adhesive, so that the peripheral edge of the screen is dynamically distorted.

For solving problems caused by a printing level difference of a front transparent member as described above, a soft and thick pressure sensitive adhesive sheet is used for bonding the front transparent plate, so that level difference absorbency is imparted. For example, JP-A-2012-237965, JP-A-2014-115468, JP-A-2011-74308 and JP-A-2010-189545 describe that the storage elastic modulus of a pressure sensitive adhesive layer to be used for bonding an optical film and a front transparent plate is set to a specific range. JP-A-2014-115468 describe a method in which a photocurable pressure sensitive adhesive is used and light irradiation is performed after bonding to cure the pressure sensitive adhesive. According to this method, the elastic modulus of the pressure sensitive adhesive is increased by the photocuring thereby improving long-term reliability of bonding, while generation of bubbles in the vicinity of a printing level difference during bonding is suppressed.

### SUMMARY OF THE INVENTION

### Problems to be Solved by the Invention

When a pressure sensitive adhesive sheet which is soft (has a low storage elastic modulus and small residual stress) and has a large thickness is used as described above, generation of bubbles in the vicinity of a printing level difference and occurrence of display unevenness at the peripheral edge of a screen can be suppressed. However, since a soft pressure sensitive adhesive is easily fluidized, the pressure sensitive adhesive at the end surface of a product cut to a predetermined size easily protrudes, so that defects such as deposition of foreign matters and mutual cohesion of products may occur. In the process for formation of an image display device, a pressurization/heating treatment by an autoclave treatment etc. is often performed for the purpose of suppressing generation of bubbles (delay bubbles) on the periphery of a printing level difference portion after bonding. When the fluidity of the pressure sensitive adhesive is high at this time, the pressure sensitive adhesive may protrude from the end surface to contaminate the inside of a bonding device.

Particularly, as the demand for thickness reduction of image display devices increases, reduction of the thickness of the pressure sensitive is required, and therefore it is necessary to further increase the fluidity of the pressure sensitive adhesive for suppressing display unevenness. Accordingly, protrusion of the pressure sensitive adhesive from the end surface tends to be more noticeable.

For suppressing defects resulting from protrusion of the pressure sensitive adhesive from the end surface, JP-A-2012-237965 discloses to perform cutting or processing in which the end surface of a pressure sensitive adhesive layer is situated inside the side surface (cut surface) of an optical film. However, since a soft pressure sensitive adhesive is easily fluidized, the pressure sensitive adhesive easily protrudes from the end surface with time during storage, transportation or the like even when the end surface of the pressure sensitive adhesive layer is situated inside the film. When the distance between the end surface of the pressure sensitive adhesive layer and the end surface of the film is excessively long, a bonding failure easily occurs in the vicinity of the printing level difference on the front transparent plate, and when the distance between the end surface of the pressure sensitive adhesive layer and the end surface of the film is excessively short, it may be unable to suppress protrusion of the pressure sensitive adhesive from the end surface.

In view of the above-described situations, an object of the present invention is to provide an optical film with a pressure sensitive adhesive, which includes a pressure sensitive adhesive layer that has level difference followability when bonded to a front transparent plate and that is prevented from significantly protruding from the end surface.

### Means for Solving the Problems

When the fluidity of a pressure sensitive adhesive at the end surface is made lower than the fluidity of a pressure sensitive adhesive at the in-plane central part, the above-mentioned problems can be solved. The present invention relates to an optical film with a pressure sensitive adhesive which is to be disposed between a front transparent plate or a touch panel and an image display cell. A first pressure sensitive adhesive layer is provided on first main surface of an optical film. The first pressure sensitive adhesive layer is used for bonding the optical film and a front transparent plate or a touch panel. The first pressure sensitive adhesive layer preferably has a thickness of 30 μm or more. In the first pressure sensitive adhesive layer, a fluidity of the pressure sensitive adhesive at an end surface is lower than a fluidity of the pressure sensitive adhesive at an in-plane central part.

The optical film with a pressure sensitive adhesive of the present invention may be an optical film with a pressure sensitive adhesive on both sides, in which a second pressure sensitive adhesive layer is further provided on second main surface of the optical film. The second pressure sensitive adhesive layer is used for bonding the optical film and the image display cell. The second pressure sensitive adhesive layer preferably has a thickness of 30 μm or less.

It is preferred that the pressure sensitive adhesive composition that forms the first pressure sensitive adhesive layer contains a radical-polymerizable compound having a carbon-carbon double bond. The radical-polymerizable compound may be present as a monomer or an oligomer in the pressure sensitive adhesive composition, or may be chemically bonded to a functional group of a base polymer of the pressure sensitive adhesive. When the radical-polymerizable compound is chemically bonded to the base polymer, a radical-polymerizable functional group can be introduced in the base polymer. When a radical-polymerizable compound is present as a monomer or an oligomer in the pressure sensitive adhesive composition, a polyfunctional polymerizable compound having two or more polymerizable functional groups per molecule is preferably used.

It is preferred that a pressure sensitive adhesive composition that forms the first pressure sensitive adhesive layer further includes a photopolymerization initiator. When the pressure sensitive adhesive composition is a photocurable pressure sensitive adhesive containing a radical-polymerizable compound and a photopolymerization initiator, the fluidity of the pressure sensitive adhesive at the end surface of the first pressure sensitive adhesive layer can be reduced by applying an active ray such as an ultraviolet ray from the side surface of the optical film with a pressure sensitive adhesive, which has been cut to a predetermined size in conformity of the screen size of an image display device.

In the first pressure sensitive adhesive layer, a gel fraction of the pressure sensitive adhesive at the end surface is preferably higher by 5% or more than a gel fraction of the pressure sensitive adhesive at the in-plane central part. The gel fraction of the pressure sensitive adhesive at the end surface of the first pressure sensitive adhesive layer is preferably 55% or more. The gel fraction of the pressure sensitive adhesive at the in-plane central part of the first pressure sensitive adhesive layer is preferably less than 55%. It is preferred that the pressure sensitive adhesive at the central part of the first pressure sensitive adhesive layer has a storage elastic modulus of 1×10⁴ Pa to 1×10⁶ Pa at 25° C.

The pressure sensitive adhesive composition that forms the first pressure sensitive adhesive layer preferably has an acryl-based base polymer content of 50% by weight or more based on a total amount of solid components. The acryl-based base polymer preferably contains a hydroxy group-containing monomer unit as a monomer unit, and a content of the hydroxy group-containing monomer unit is preferably 3 to 50% by weight based on a total amount of constituent monomer units.

In the optical film with a pressure sensitive adhesive according to the present invention, the fluidity of the pressure sensitive adhesive at the end surface of the first pressure sensitive adhesive layer is low, resulting in reduced protrusion of the pressure sensitive adhesive from the end surface. Therefore, contamination due to protrusion of the pressure sensitive adhesive during bonding, and cohesion of products during storage, transportation or the like can be suppressed. At the in-plane central part of the first pressure sensitive adhesive layer, the fluidity of the pressure sensitive adhesive is high, resulting in excellent printing level difference absorbency when the optical film is bonded to a front transparent member such as a touch panel or a front transparent plate, and thus defects caused by the printing level difference, such as display unevenness at the peripheral edge of a screen, can be suppressed.

The present invention also relates to a method for producing and image display device having a front transparent plate or a touch panel, an optical film including a polarizing plate, and an image display cell, arranged in this order from a viewing side. In the production of the image display device, the optical film is bonded to a front transparent plate or a touch panel with the first pressure sensitive adhesive layer interposed therebetween (viewing-side bonding step). When the pressure sensitive adhesive composition that forms the first pressure sensitive adhesive layer contains a radical-polymerizable compound and a photopolymerization initiator, it is preferred that the first pressure sensitive adhesive layer is cured by applying an active ray from the front transparent plate or touch panel side after the viewing-side bonding step.

When a photopolymerizable pressure sensitive adhesive is used as a pressure sensitive adhesive for bonding a front transparent plate or a touch panel and an optical film to each other, protrusion of the pressure sensitive adhesive from the end surface, etc. can be suppressed by selectively photocuring the pressure sensitive adhesive at the end surface by application of an active ray from the side surface of the optical film with a pressure sensitive adhesive. When the front transparent plate or touch panel and the optical film are bonded to each other while the pressure sensitive adhesive at the in-plane central part is kept uncured to maintain high fluidity, generation of bubbles in the vicinity of the printing level difference and occurrence of display unevenness at the peripheral edge of a screen can be suppressed. By applying an active ray from the front transparent plate or touch panel side after bonding the optical film thereto, the pressure sensitive adhesive at the in-plane central part can be cured to improve adhesiveness.

### BRIEF DESCRIPTION OF THE DRAWINGS

FIG. 1A is a plane view schematically showing one embodiment of an optical film with a pressure sensitive adhesive, and FIG. 1B shows the cross section diagram along the line B1-B2 in FIG. 1A.

FIG. 2 is a sectional view schematically showing one embodiment of an image display device.

FIG. 3 is a graph for explaining how to determine the width W₁ of the cured portion of a pressure sensitive adhesive layer.

### DESCRIPTION OF EMBODIMENTS

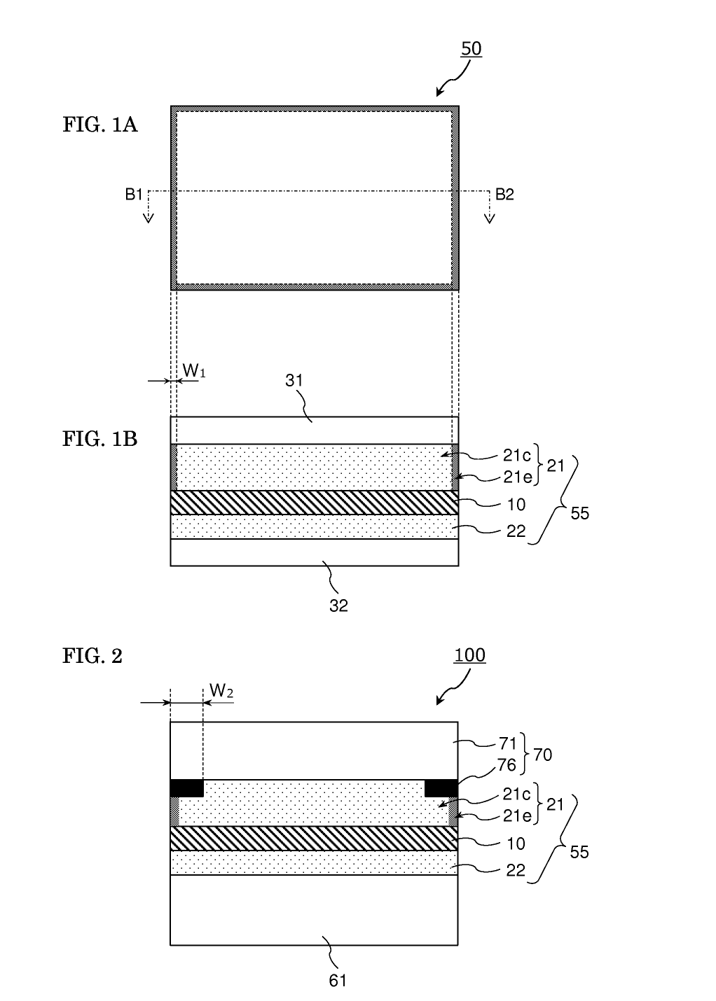

FIG. 1 shows one embodiment of an optical film with a pressure sensitive adhesive according to the present invention. FIG. 1A is a plan view, and FIG. 1B is a cross section diagram along the line B1-B2 in FIG. 1A. FIG. 2 is a sectional view schematically showing one embodiment of an image display device 100 formed using an optical film with a pressure sensitive adhesive 55.

The optical film with a pressure sensitive adhesive 55 as shown in FIG. 1B includes a first pressure sensitive adhesive layer 21 on one surface (first main surface) of an optical film 10. In the embodiment shown in FIG. 1B, a protective sheet 31 is releasably attached on the first pressure sensitive adhesive layer 21. The first main surface provided with the first pressure sensitive adhesive layer 21 is a surface that is on the viewing side in formation of an image display device. The first pressure sensitive adhesive layer 21 is used for bonding the optical film 10 to a front transparent member 70 such as a front transparent plate or a touch panel.

The other surface (second main surface) of the optical film 10 may be provided with a second pressure sensitive adhesive layer 22 as shown in FIG. 1B. In the embodiment shown in FIG. 1B, a protective sheet 32 is releasably attached on the second pressure sensitive adhesive layer 22. The second main surface provided with the second pressure sensitive adhesive layer 22 is disposed on the side of an image display cell 61 such as a liquid crystal cell or an organic EL cell in formation of an image display device. The second pressure sensitive adhesive layer 22 is used for bonding the optical film 10 and the image display cell 61 to each other.

[Optical Film]

The optical film 10 includes a polarizing plate. As the polarizing plate, one having an appropriate transparent protective film laminated on one surface or both surfaces of a polarizer as necessary is generally used. The polarizer is not particularly limited, and various kinds of polarizers may be used. Examples of the polarizer include films obtained by impregnating a dichroic material such as iodine or a dichroic dye into a hydrophilic polymer film such as a polyvinyl alcohol-based film, a partially formalized polyvinyl alcohol-based film or an ethylene-vinyl acetate copolymer-based partially saponified film, and uniaxially stretching the film; and polyene-based oriented films such as those of dehydrated products of polyvinyl alcohol and dehydrochlorinated products of polyvinyl chloride.

For the transparent protective film as a protective film for the polarizer, a resin excellent in transparency, mechanical strength, thermal stability, moisture barrier property and optical isotropy, such as a cellulose-based resin, a cyclic polyolefin-based resin, an acryl-based resin, a phenylmaleimide-based resin or a polycarbonate-based resin, is preferably used. When a transparent protective film is provided on each of both surfaces of the polarizer, protective films formed of the same polymer material may be used or protective films formed of different polymer materials may be used on the front surface and the back surface. For the purpose of, for example, optical compensation and wide viewing of a liquid crystal cell, an optically anisotropic film such as a retardation sheet (stretched film) can also be used as a protective film for the polarizer.

The optical film 10 may be consisting of the polarizing plate. The optical film 10 may include other films laminated on one surface or both surfaces of the polarizing plate with an appropriate adhesive layer or a pressure sensitive adhesive layer interposed therebetween as necessary. The type of the films laminated on the polarizing plate is not particularly limited. Films generally used for formation of an image display device, such as retardation sheets, wide-viewing films, viewing angle restriction (peep prevention) films and brightness enhancement films may be laminated on the polarizing plate. For example, in a liquid crystal display device, an optical compensation film may be arranged between the image display cell (liquid crystal cell) and the polarizing plate for the purpose of, for example, improving viewing angle properties by appropriately changing the polarized state of light emitted from the liquid crystal cell to the viewing side. In the organic EL display device, a quarter wave plate may be arranged between the cell and the polarizing plate for the purpose of inhibiting external light from being reflected at a metal electrode layer to cause the surface to be viewed like a mirror surface. When a quarter wave plate is arranged on a viewing side of the polarizing plate, linearly polarized light emitted from the polarizing plate is converted into circularly polarized light, so that a proper displayed image can be made visible even to a viewer wearing polarizing sunglasses.

A surface of the optical film 10 may be provided with a hard coat layer, or subjected to an antireflection treatment, or a treatment intended for prevention of sticking, diffusion or antiglare. A surface of the optical film 10 may be subjected to a surface modification treatment for the purpose of, for example, improving adhesiveness before the pressure sensitive adhesive layers 21 and 22 are provided thereon. Specific examples of the treatment include a corona treatment, a plasma treatment, a flame treatment, an ozone treatment, a primer treatment, a glow treatment, a saponification treatment, and a treatment with a coupling agent. An antistatic layer may also be formed.

[First Pressure Sensitive Adhesive Layer]

The first pressure sensitive adhesive layer 21 provided on the optical film 10 is used for bonding the optical film to the front transparent member 70 such as a front transparent plate or a touch panel. When an optical film with a pressure sensitive adhesive, in which the pressure sensitive adhesive layer 21 is provided on a surface of the optical film 10, is used, it is not necessary to provide a liquid adhesive or an extra sheet pressure sensitive adhesive on the optical film at the time of bonding to the front transparent member 70, so that the production process of the image display device can be simplified.

The thickness of the first pressure sensitive adhesive layer 21 is preferably 30 μm or more, more preferably 50 μm or more, further preferably 70 μm or more. When the thickness of the first pressure sensitive adhesive layer falls within the above-mentioned range, level difference followability can be imparted to the pressure sensitive adhesive, and therefore generation of bubbles in the vicinity of the printing level difference and occurrence of display unevenness on the peripheral edge region of the image display device can be suppressed. When the front transparent member 70 has a non-flat portion such as the printed portion 76 at the peripheral edge, the thickness of the pressure sensitive adhesive layer 21 is preferably 1.2 times or more, more preferably 1.5 times or more further preferably 2.0 times or more of the height of the non-flat portion (printed portion) 76. The upper limit of the thickness of the pressure sensitive adhesive layer 21 is not particularly limited, but is preferably 300 μm or less, further preferably 250 μm or less, from the viewpoint of lightening/thinning of the image display device and in view of ease of forming the pressure sensitive adhesive layer, and handling characteristics.

For securing level difference followability, a pressure sensitive adhesive that is soft and has high fluidity is preferably used. The index of fluidity of the pressure sensitive adhesive is a storage elastic modulus, a residual stress or the like. Even when the storage elastic modulus is unchanged, viscosity and fluidity increase as the loss tangent tan δ=G″/G′, which is a ratio of the storage elastic modulus G′ and the loss elastic modulus G″, becomes higher.

For imparting level difference followability to the pressure sensitive adhesive to suppress bubbles and display unevenness, the storage elastic modulus G′ of the first pressure sensitive adhesive layer at 25° C. is preferably 1×10⁶ Pa or less, more preferably 5×10⁵ Pa or less, further preferably 3×10⁵ Pa or less. For reducing deposition of the pressure sensitive adhesive on a cutting blade at the time when the optical film with a pressure sensitive adhesive is cut to a desired size, the storage elastic modulus G′ of the first pressure sensitive adhesive layer at 25° C. is preferably 1×10⁴ Pa or more, more preferably 2×10⁴ Pa or more, further preferably 3×10⁴ Pa or more.

At the time when the front transparent member such as a touch panel or a front transparent plate and the optical film are bonded to each other with the pressure sensitive adhesive layer interposed therebetween, a pressurization/heating treatment is often performed by an autoclave treatment after the bonding is performed under a heating environment for the purpose of removal of bubbles, etc. Preferably, the first pressure sensitive adhesive layer 21 has high fluidity at the time of bonding the optical film to the front transparent member. Therefore, the storage elastic modulus G′_{80° C.} of the first pressure sensitive adhesive layer at 80° C. is preferably 1×10⁵ Pa or less, more preferably 5×10⁴ Pa or less, further preferably 3×10⁴ Pa or less, particularly preferably 1×10⁴ Pa or less.

In this specification, the storage elastic modulus G′ is determined by reading a value at a predetermined temperature in measurement performed at a temperature elevation rate of 5° C./minute in a range of −50 to 150° C. under the condition of a frequency of 1 Hz in accordance with the method described in JIS K 7244-1 “Plastics—Determination of Dynamic Mechanical Properties”. The elastic modulus of a material exhibiting viscoelasticity, such as a pressure sensitive adhesive, can be represented by a storage elastic modulus G′ and a loss elastic modulus G″. In general, the loss elastic modulus G″ is an index indicating a degree of viscosity, while the storage elastic modulus G′ is used as an index indicating a degree of hardness.

For imparting level difference followability to the pressure sensitive adhesive to suppress bubbles and display unevenness, the residual stress of the first pressure sensitive adhesive layer at 25° C. is preferably 6 N/cm² or less, more preferably 5.5 N/cm² or less, further preferably 5 N/cm² or less. The residual stress is preferably 0.1 N/cm² or more. The residual stress in this specification is measured by a tensile stress relaxation test under the conditions of a temperature of 25° C., a strain of 300% and a relaxation time of 180 seconds. Specifically, the residual stress is a stress (tensile stress) after elapse of 180 seconds after the pressure sensitive adhesive is deformed at a tension speed of 200 mm/minute by a tension tester until the strain reaches 300% (4 times as large as the original length). The residual stress correlates with the storage elastic modulus, and the residual stress tends to increase as the storage elastic modulus becomes larger.

As the first pressure sensitive adhesive layer to be provided on the first main surface of the optical film 10, one having a low storage elastic modulus and residual stress, and high fluidity is preferably used for suppressing bubbles and display unevenness caused by the level difference of the printed portion 76 of the front transparent member 70 as described above. On the other hand, when the fluidity of the pressure sensitive adhesive is high, the pressure sensitive adhesive easily protrudes from the end surface of the optical film with a pressure sensitive adhesive. If the pressure sensitive adhesive protrudes from the end surface of the optical film with a pressure sensitive adhesive, which is cut to a predetermined size in conformity with the screen size of the image display device, defects such as deposition of foreign matters on the end surface and mutual cohesion of superimposed products easily occur during storage or transportation. If the pressure sensitive adhesive protrudes from the end surface due to pressurization at the time of bonding the optical film to the front transparent member, the inside of an apparatus such as a laminator or an autoclave is contaminated.

In the present invention, protrusion of the pressure sensitive adhesive from the end surface can be suppressed by reducing the fluidity of a pressure sensitive adhesive 21e at the end surface while ensuring that a pressure sensitive adhesive 21c at the in-plane central part of the first pressure sensitive adhesive layer 21 has high fluidity as described above. Preferably, the fluidity of the pressure sensitive adhesive is reduced over the entire end surface of the optical film with a pressure sensitive adhesive as shown in FIG. 1A. For example, when the optical film with a pressure sensitive adhesive is cut to a rectangle, it is preferred that the fluidity of the pressure sensitive adhesive at the in-plane central part is lower than the fluidity of the pressure sensitive adhesive at the end surface on all the four sides of the rectangle.

The method for reducing the fluidity of the pressure sensitive adhesive at the end surface is not particularly limited. For example, when a pressure sensitive adhesive having low fluidity is provided in the vicinity of the end surface, and a pressure sensitive adhesive having high fluidity is provided at the in-plane central part, the pressure sensitive adhesive at the end surface can be selectively made to have low fluidity. From the viewpoint of productivity and processability, for example, a method is preferable in which the curable pressure sensitive adhesive layer 21 is provided over the whole surface of the optical film, and the pressure sensitive adhesive 21e at the end surface is selectively cured to increase the crosslinking degree.

The curable pressure sensitive adhesive contains a base polymer and a polymerizable compound, and the polymerizable compound cross-links the base polymer by means of light and heat to increase the gel fraction (crosslinking degree), so that fluidity can be reduced. As the polymerizable component, a radical-polymerizable compound (ethylenically unsaturated compound) having a carbon-carbon double bond (C═C bond) is preferably used. The radical-polymerizable compound may be present as a monomer or an oligomer in the pressure sensitive adhesive composition, or may be chemically bonded to a functional group such as a hydroxy group of the base polymer. As the curable pressure sensitive adhesive, one containing a polymerization initiator (photopolymerization initiator or thermopolymerization initiator) is preferable.

By mixing, with the base polymer, a radical-polymerizable compound having a functional group capable of being chemically bonded to a functional group of the base polymer and a radical-polymerizable functional group, the radical-polymerizable functional group can be introduced into the base polymer to form the pressure sensitive adhesive composition into a curable pressure sensitive adhesive. As the functional group capable of being chemically bonded to a functional group of the base polymer, an isocyanate group is preferable. The isocyanate group forms a urethane bond with a hydroxy group of the base polymer, so that a radical-polymerizable functional group can be easily introduced into the base polymer. Examples of the radical-polymerizable compound containing an isocyanate group and a polymerizable functional group include (meth)acryloyl isocyanate, 2-(meth)acryloyloxyethyl isocyanate and misopropenyl-α,α-dimethylbenzyl isocyanate. When the radical-polymerizable compound has a functional group capable of being bonded to a functional group of the base polymer, the number of radical-polymerizable functional groups per molecule in the radical-polymerizable compound may be 1, or may be 2 or more. Examples of the isocyanate compound having a plurality of radical-polymerizable functional groups per molecule may include 1,1-(bis(meth)acryloyloxymethyl)ethyl isocyanate.

When a radical-polymerizable compound is present as a monomer or an oligomer in the pressure sensitive adhesive composition, a polyfunctional polymerizable compound having two or more polymerizable functional groups per molecule is preferably used. Examples of the polyfunctional polymerizable compound include compounds having two or more C═C bonds per molecule, and compounds having one C═C bond, and a polymerizable functional group such as epoxy, aziridine, oxazoline, hydrazine or methylol. Among them, polyfunctional polymerizable compounds having two or more C═C bonds, like polyfunctional acrylates, are preferable. Concrete examples of the polyfunctional polymerizable compound include polyethylene glycol di(meth)acrylate, polypropylene glycol di(meth)acrylate, polytetramethylene glycol di(meth)acrylate, bisphenol A ethylene oxide-modified di(meth)acrylate, bisphenol A propylene oxide-modified (meth)acrylate, alkanediol di(meth)acrylate, tricyclodecane dimethanol di(meth)acrylate, ethoxylated isocyanuric acid triacrylate, pentaerythritol tri(meth)acrylate, pentaerythritol di(meth)acrylate, trimethylolpropane tri(meth)acrylate, ditrimethylolpropane tetra(meth)acrylate, ethoxylated pentaerythritol tetra(meth)acrylate, pentaerythritol tetra(meth)acrylate, dipentaerythritol poly(meth)acrylate, dipentaerythritol hexa(meth)acrylate, neopentyl glycol di(meth)acrylate, glycerin di(meth)acrylate, urethane (meth)acrylate, epoxy (meth)acrylate, butadiene (meth)acrylate and isoprene (meth)acrylate.

When a large-area optical film with a pressure sensitive adhesive is cut to a predetermined size in conformity to the screen size of image display, curing of the pressure sensitive adhesive may be performed either before or after the cutting. For example, a portion to be cut (cutting-planned location) is position selectively irradiated with light or heated to cure the pressure sensitive adhesive, and the cured portion is then cut to obtain an optical film with a pressure sensitive adhesive in which the pressure sensitive adhesive 21e at the end surface is cured. The end surface after the optical film is cut to a predetermined size may be heated or irradiated with light to cure the pressure sensitive adhesive 21e at the end surface.

The region where the fluidity of the pressure sensitive adhesive is low may have a size which ensures that protrusion of the pressure sensitive adhesive from the end surface due to fluidity of the pressure sensitive adhesive can be suppressed. The width W₁ from the end surface, of the region where the fluidity of the pressure sensitive adhesive is low can be adjusted according to the fluidity, composition and the like of the pressure sensitive adhesive. The width W₁ may be, for example, about 10 μm or more. The width W₁ of the region where the fluidity of the pressure sensitive adhesive is low is preferably 30 μm or more, more preferably 50 μm or more. On the other hand, when the width W₁ increases, the fluidity of the pressure sensitive adhesive on the periphery of the printed portion 76 is low at the time of bonding the optical film to the front transparent member 70, which may cause bubbles and display unevenness. Thus, the width W₁ is preferably 3000 μm or less, more preferably 2000 μm or less, further preferably 1000 μm or less. The width W₁ is preferably smaller than the width W₂ of the printed portion 76 of the front transparent member 70. For suppressing bubbles and display unevenness caused by the printing level difference, the ratio of W₁ to W₂ is more preferably 0.8 or less, further preferably 0.6 or less.

For adjusting the width W₁ of the region where the fluidity of the pressure sensitive adhesive is low falls within the above-mentioned range, a method is preferable in which after the optical film is cut to a predetermined size, an active ray such as an ultraviolet ray is applied from the cut surface (end surface) to photocure the pressure sensitive adhesive 21e at the end surface. Accordingly, it is preferred that the curable pressure sensitive adhesive of the first pressure sensitive adhesive layer 21 contains a radical-polymerizable compound and a photopolymerization initiator. When an active ray is applied from the end surface, the width W₁ of the region where the fluidity of the pressure sensitive adhesive is low can be adjusted by adjusting the wavelength of applied light, the integrated light amount, or the like.

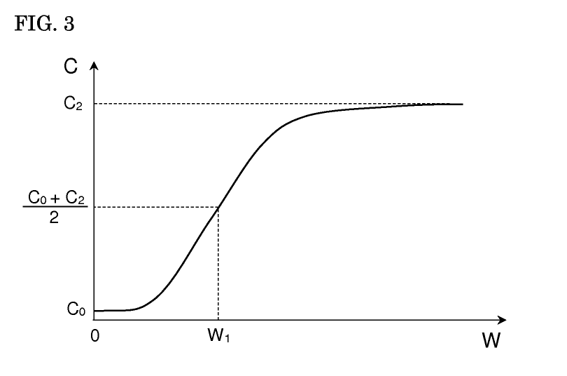

FIG. 3 is a graph schematically showing a relationship between the distance W from the end surface and the C═C bond content C in the pressure sensitive adhesive for the pressure sensitive adhesive photocured by applying an active ray from the end surface. For example, a change in C═C bond content with respect to the distance W can be determined by measuring a C═C bond-derived absorbance around 1640 cm⁻¹ by infrared microspectrometry. At the point where the distance W is 0 (i.e. the end surface), curing most progresses, and the C═C bond content C₀ is close to 0 as shown in FIG. 3. On the other hand, at the central part distant from the end surface, curing hardly progresses, and the unreacted C═C bond content C₂ is almost equal to the C═C bond content before an active ray is applied from the end surface. When progress of curing varies depending on the distance from the end surface, the distance between the end surface and the position at which the C═C bond content equals an average of the C═C bond content C₀ in the pressure sensitive adhesive at the end surface and the C═C bond content C₂ in the pressure sensitive adhesive at the in-plane central portion (i.e. (C₀+C₂)/2) can be defined as the width W₁ of the region where the fluidity of the pressure sensitive adhesive is low. The in-plane central part of the pressure sensitive adhesive layer is a region where the fluidity of the pressure sensitive adhesive is higher as compared to the vicinity of the end surface, the region being surrounded by a region where the fluidity of the pressure sensitive adhesive is low.

When the end surface is cured, the gel fraction of the pressure sensitive adhesive 21e at the end surface becomes higher than the gel fraction of the pressure sensitive adhesive 21c at the in-plane central part of the first pressure sensitive adhesive layer 21. The gel fraction of the pressure sensitive adhesive at the end surface is higher than that at the in-plane central part preferably by 5% or more, more preferably by 8% or more, further preferably by 10% or more.

The gel fraction of the pressure sensitive adhesive can be determined as a content of components insoluble in a solvent, and specifically, it is determined as a weight fraction (unit: % by weight) of insoluble components after immersion of the pressure sensitive adhesive in a solvent at 23° C. for 7 days to the sample before immersion. When the pressure sensitive adhesive is an acryl-based pressure sensitive adhesive, ethyl acetate is used as a solvent. When the gel fraction of the pressure sensitive adhesive at the end surface is to be measured, the pressure sensitive adhesive collected from the region of 200 μm or less from the end surface is used. Generally, the gel fraction of a polymer is equal to the crosslinking degree, and the larger the amount of the crosslinked portion in the polymer is, the higher the gel fraction becomes. When the composition of the pressure sensitive adhesive is unchanged, fluidity is reduced as the gel fraction increases.

The optimum value of the gel fraction of each of the pressure sensitive adhesives at the end surface and at the in-plane central portion varies depending on the composition of the pressure sensitive adhesive, etc. For suppressing protrusion of the pressure sensitive adhesive from the end surface, the gel fraction of the pressure sensitive adhesive 21e at the end surface is preferably 55% or more, more preferably 58% or more, further preferably 60% or more. For securing followability to the printing level difference of the front transparent plate, the gel fraction of the pressure sensitive adhesive 21c at the in-plane central portion is preferably less than 55%, more preferably 52% or less, further preferably 50% or less.

The residual stress of the pressure sensitive adhesive 21e at the end surface at 25° C. after curing is preferably 1.5 N/cm² or more, more preferably 2.0 N/cm² or more, further preferably 2.2 N/cm² or more. The storage elastic modulus of the pressure sensitive adhesive 21e at the end surface at 25° C. after curing is preferably 5×10⁴ Pa or more, more preferably 7×10⁴ Pa or more, further preferably 8×10⁴ Pa or more, especially preferably 9×10⁴ Pa or more. The region of the pressure sensitive adhesive, which is cured by applying light from the side surface, has a small width (area), so that it is difficult to directly measure the residual stress and storage elastic modulus of the pressure sensitive adhesive at the end surface. By separately determining a relationship between the gel fraction and the residual stress or the storage elastic modulus using curable pressure sensitive adhesives having the same composition, the storage elastic modulus and the residual stress can be calculated from the measured value of the gel fraction of the pressure sensitive adhesive at the end surface. The residual stress and the storage elastic modulus increase as the gel fraction increases. Generally, the residual stress tends to linearly increase as the gel fraction increases.

Composition of the pressure sensitive adhesive that forms the first pressure sensitive adhesive layer 21 is not particularly limited, one containing as a base polymer an acryl-based polymer, a silicone-based polymer, a polyester, a polyurethane, a polyamide, a polyvinyl ether, a vinyl acetate/vinyl chloride copolymer, a modified polyolefin, an epoxy-based polymer, a fluorine-based polymer, or a polymer based on a rubber such as a natural rubber or a synthetic rubber can be appropriately selected and used. For the first pressure sensitive adhesive layer 21, a pressure sensitive adhesive excellent in optical transparency is preferably used because it is used in an image display device. Specifically, it is preferred that the first pressure sensitive adhesive layer 21 has a haze of 1.0% or less, and a total light transmittance of 90% or more. It is preferred that the second pressure sensitive adhesive layer 22 also has a haze of 1.0% or less, and a total light transmittance of 90% or more.

As a pressure sensitive adhesive excellent in optical transparency and adhesiveness, an acryl-based pressure sensitive adhesive containing an acryl-based polymer as a base polymer is preferably used. In the acryl-based pressure sensitive adhesive, the content of the acryl-based base polymer based on the total amount of solid components in the pressure sensitive adhesive composition is preferably 50% by weight or more, more preferably 70% by weight or more, further preferably 80% by weight or more.

As the acryl-based polymer, one having a monomer unit of a (meth)acrylic acid alkyl ester as a main skeleton is suitably used. In this specification, the “(math)acryl” means acryl and/or methacryl.

As the (meth)acrylic acid alkyl ester, a (meth)acrylic acid alkyl ester with the alkyl group having 1 to 20 carbon atoms is preferably used. Examples of the (meth)acrylic acid alkyl ester include methyl (meth)acrylate, ethyl (meth)acrylate, butyl (meth)acrylate, isobutyl (meth)acrylate, s-butyl (meth)acrylate, t-butyl (meth)acrylate, pentyl (meth)acrylate, isopentyl (meth)acrylate, neopentyl (meth)acrylate, hexyl (meth)acrylate, heptyl (meth)acrylate, 2-ethylhexyl (meth)acrylate, octyl (meth)acrylate, isooctyl (meth)acrylate, nonyl (meth)acrylate, isononyl (meth)acrylate, decyl (meth)acrylate, isodecyl (meth)acrylate, undecyl (meth)acrylate, dodecyl (meth)acrylate, isotridodecyl (meth)acrylate, tetradecyl (meth)acrylate, isotetradecyl (meth)acrylate, pentadecyl (meth)acrylate, cetyl (meth)acrylate, heptadecyl (meth)acrylate, octadecyl (meth)acrylate, isooctadecyl (meth)acrylate, nonadecyl (meth)acrylate and alakyl (meth)acrylate.

The content of the (meth)acrylic acid alkyl ester is preferably 40% by weight or more, more preferably 50% by weight or more, further preferably 60% by weight or more based on the total amount of monomer components that form the base polymer.

The acryl-based base polymer may be a copolymer of a plurality of (meth)acrylic acid alkyl esters. The arrangement of constituent monomer units may be random, or blockwise. The alkyl group may have a branch. By using a (meth)acrylic acid alkyl ester having a branch, flexibility can be imparted to the pressure sensitive adhesive. As the branched alkyl (meth)acrylic acid ester, 2-ethylhexyl (meth)acrylate, isooctyl (meth)acrylate, isononyl (meth)acrylate, isodecyl (meth)acrylate, isotetradecyl (meth)acrylate, isooctadecyl (meth)acrylate or the like is suitably used. Two or more branched alkyl (meth)acrylic acid esters may be used in combination. These branched (meth)acrylic acid alkyl esters may be used in combination with a linear (meth)acrylic acid ester.

The acryl-based base polymer preferably contains an acryl-based monomer unit having a crosslinkable functional group as a copolymer component. When the base polymer has a crosslinkable functional group, the gel fraction of the pressure sensitive adhesive can be easily increased by thermal crosslinking, photocuring or the like of the base polymer. Examples of the acryl-based monomer having a crosslinkable functional group include hydroxy group-containing monomers and carboxy group-containing monomers. Particularly, it is preferred that a hydroxy group-containing monomer is contained as the copolymer component of the base polymer. When the base polymer has a hydroxy group-containing monomer as a monomer unit, the crosslinkability of the base polymer is improved, and cloudiness of the pressure sensitive adhesive under a high-temperature and high-humidity environment tends to be suppressed, so that a pressure sensitive adhesive having high transparency is obtained.

Examples of the hydroxy group-containing monomer include 2-hydroxyethyl (meth)acrylate, 2-hydroxypropyl (meth)acrylate, 4-hydroxybutyl (meth)acrylate, 6-hydroxyhexyl (meth)acrylate, 8-hydroxyoctyl (meth)acrylate, 10-hydroxydecyl (meth)acrylate, 12-hydroxylauryl (meth)acrylate and (4-hydroxymethylcyclohexyl)-methyl (meth)acrylate. The content of the hydroxy group-containing monomer unit is preferably 3 to 50% by weight, more preferably 5 to 40% by weight, further preferably 7 to 30% by weight based on the total amount of constituent monomer units of the base polymer.

Preferably, the acryl-based base polymer contains, in addition to the above mentioned (meth)acrylic acid alkyl ester and hydroxy group-containing monomer unit, a monomer unit having high polarity, such as a nitrogen-containing monomer. When the acryl-based base polymer contains a high-polarity monomer unit such as a nitrogen-containing monomer unit in addition to a hydroxy group-containing monomer unit, the pressure sensitive adhesive has high adhesiveness and retentive strength, and cloudiness under a high-temperature and high-humidity environment is suppressed.

Examples of the nitrogen containing monomer include vinyl-based monomer such as N-vinylpyrrolidone, methylvinylpyrrolidone, vinylpyridine, vinylpiperidone, vinylpyrimidine, vinylpiperazine, vinylpyrazine, vinylpyrrole, vinylimidazole, vinyloxazole, vinylmorpholine, (meth)acryloylmorpholine, N-vinylcarboxylic acid amides and N-vinylcaprolactam; and cyano group containing monomer such as acrylonitrile and methacrylonitrile. Among them, N-vinylpyrrolidone and (meth)acryloylmorpholine are preferably used. The content of the nitrogen-containing monomer unit is preferably 3 to 50% by weight, more preferably 5 to 40% by weight, further preferably 7 to 30% by weight based on the total amount of constituent monomer units of the base polymer.

Besides the above-described compounds, acid anhydride group-containing monomers, caprolactone adducts of acrylic acids, sulfonic acid group-containing monomers and phosphoric acid group-containing monomers, or the like can be used as the copolymerizable monomer component. The ratio of the copolymerizable monomer component in the acryl-based polymer is not particularly limited.

The acryl-based polymer as a base polymer can be obtained by polymerizing the monomer components using various kinds of known methods such as solution polymerization, emulsification polymerization and mass polymerization. The solution polymerization method is suitable from the viewpoint of a balance of properties such as adhesive strength and retentive strength of the pressure sensitive adhesive, costs and so on. As a solvent for solution polymerization, ethyl acetate, toluene or the like is generally used. The solution concentration is normally about 20 to 80% by weight. As the polymerization initiator, a thermopolymerization initiator such as an azo-based initiator, a peroxide-based initiator, a redox-based initiator obtained by combining a peroxide and a reducing agent (e.g., combination of a persulfate and sodium hydrogen sulfite, combination of a peroxide and sodium ascorbate, or the like) is preferably used. The usage amount of the polymerization initiator is not particularly limited, and is for example about 0.005 to 5 parts by weight, preferably about 0.02 to 3 part by weight based on 100 parts by weight of the total amount of monomer components that form the base polymer.

For adjusting the molecular weight of the base polymer, a chain-transfer agent may be used. The chain-transfer agent can receive radicals from a growing polymer chain to stop extension of the polymer, and the chain-transfer agent having received the radicals can attack the monomer to start polymerization again. Accordingly, when a chain-transfer agent is used, an increase in molecular weight of the base polymer is inhibited without reducing the concentration of radicals in the reaction system, so that a pressure sensitive adhesive sheet having high fluidity can be obtained. As the chain-transfer agent, for example, a thiol such as α-thioglycerol, lauryl mercaptan, glycidyl mercaptan, mercaptoacetic acid, 2-mercaptoethanol, thioglycolic acid, 2-ethylhexyl thioglycollate or 2,3-dimercapto-1-propanol is suitably used. The usage amount of chain-transfer agent is not particularly limited, and is for example 2 parts by weight or less, preferably 1 part by weight or less based on 100 parts by weight of the total amount of monomer components that form the base polymer.

The pressure sensitive adhesive that forms the first pressure sensitive adhesive layer 21 may have a crosslinked structure. The crosslinked structure is formed by, for example, adding a crosslinker after polymerization of the base polymer. As the crosslinker, a common cross linker can be used, such as an isocyanate-based crosslinker, an epoxy-based crosslinker, an oxazoline-based crosslinker, an aziridine-based crosslinker, a carbodiimide-based crosslinker or a metal chelate-based crosslinker. The crosslinker can form a crosslinked structure by reacting with a functional group such as a hydroxy group introduced into the base polymer. The content of the crosslinker is normally 10 parts by weight or less, preferably 5 parts by weight or less, further preferably 3 parts by weight or less based on 100 parts by weight of the base polymer. When the content of the crosslinker is excessively high, the flexibility (fluidity) of the pressure sensitive adhesive is reduced, so that adhesion to an adherend may be reduced, and ingress of bubbles and display unevenness resulting from the printing level difference of the front transparent plate may occur.

For the purpose of adjusting the adhesive strength, a silane coupling agent can also be added in the pressure sensitive adhesive composition. The silane coupling agent may be used by one kind singly or two or more kinds in combination. When the pressure sensitive adhesive composition includes a silane coupling agent, the content thereof is normally about 0.01 to 5.0 parts by weight, preferably 0.03 to 2.0 parts by weight based on 100 parts by weight of the base polymer.

The pressure sensitive adhesive composition may contain a tackifier as necessary. As the tackifier, for example, a terpene-based tackifier, a styrene-based tackifier, a phenol-based tackifier, a rosin-based tackifier, an epoxy-based tackifier, a dicyclopentadiene-based tackifier, a polyamide-based tackifier, a ketone-based tackifier, an elastomer-based tackifier or the like can be used. When the pressure sensitive adhesive composition contains a tackifier, the content thereof is preferably about 5 to 300 parts by weight, more preferably about 10 to 150 parts by weight based on 100 parts by weight of the base polymer.

In addition to the components exemplified above, additives such as a plasticizer, a softener, a degradation inhibitor, a filler, a colorant, an ultraviolet ray absorber, an antioxidant, a surfactant and an antistatic agent can be used in the pressure sensitive adhesive composition within the bounds of not impairing the feature of the present invention.

As described above, the pressure sensitive adhesive that forms the first pressure sensitive adhesive layer 21 is preferably photocurable or thermosetting pressure sensitive adhesive for reducing the fluidity of the pressure sensitive adhesive at the end surface of the optical film with a pressure sensitive adhesive. The photocurable or thermosetting pressure sensitive adhesive contains a radical-polymerizable compound in addition to a base polymer and a crosslinker. As the radical-polymerizable compound, a compound having a functional group capable of being bonded to a functional group of the base polymer, and a radical-polymerizable functional group, or polyfunctional polymerizable compound is preferably used. These compounds may be used in combination. The content of the radical-polymerizable compound is preferably 0.5 to 30 parts by weight, more preferably 1 to 20 parts by weight based on 100 parts by weight of the base polymer. When the content of the radical-polymerizable compound falls within the above-mentioned range, the fluidity of the pressure sensitive adhesive before and after curing can be adjusted to fall within a preferable range.

For bonding the radical-polymerizable compound to the base polymer, it is preferred that the radical-polymerizable compound is added after polymerization of the base polymer. For ensuring that the radical-polymerizable compound is present as a monomer or an oligomer in the pressure sensitive adhesive composition, it is preferred that the radical-polymerizable compound is added after polymerization of the base polymer and after crosslinking is performed as necessary.

When the first pressure sensitive adhesive layer 21 is a photocurable pressure sensitive adhesive, it is preferred that the pressure sensitive adhesive composition contains a photopolymerization initiator. As the photopolymerization initiator, a compound having one or more radical generation points in the molecule is used, and examples thereof include hydroxyketones, benzyl dimethyl ketals, aminoketones, acylphosphine oxides, benzophenones and trichloromethyl-containing triazine derivatives. Among them, those capable of generating radicals when irradiated with light having a short wavelength of 300 nm or less are preferably used. Light having a short wavelength is hard to take a roundabout path, and therefore when light is applied from the end surface (side surface) of the pressure sensitive adhesive layer, the vicinity of the end surface can be selectively cured. Accordingly, the width W₁ of the region where the fluidity of the pressure sensitive adhesive is low is easily controlled, so that protrusion of the pressure sensitive adhesive from the end surface can be suppressed, and excessive curing of the pressure sensitive adhesive in the vicinity of the printing level difference is suppressed to prevent bubbles and display unevenness being generated. The content of the photopolymerization initiator is preferably 0.01 to 5 parts by weight, more preferably 0.05 to 3 parts by weight based on 100 parts by weight of the base polymer.

[Second Pressure Sensitive Adhesive Layer]

As shown in FIG. 1B, the optical film with a pressure sensitive adhesive preferably includes a second pressure sensitive adhesive layer 22 on the second main surface (the image display cell 61 side surface) of the optical film 10. The thickness of the second pressure sensitive adhesive layer 22 is preferably 3 μm to 30 μm, more preferably 5 μm to 27 μm, further preferably 10 μm to 25 μm. When the thickness of the second pressure sensitive adhesive layer falls within the above-mentioned range, excellent durability can be secured, and defects such as ingress of bubbles can be suppressed.

For the second pressure sensitive adhesive layer, various kinds of pressure sensitive adhesives that are used for bonding the optical film and the image display cell to each other can be used. As the pressure sensitive adhesive that forms the second pressure sensitive adhesive layer, an acryl-based pressure sensitive adhesive is preferably used. It is preferred that the second pressure sensitive adhesive layer has lower fluidity than the first pressure sensitive adhesive layer.

The storage elastic modulus G′ of the second pressure sensitive adhesive layer 22 at 25° C. is preferably 1×10⁴ Pa to 1×10⁷ Pa, more preferably 3×10⁴ Pa to 5×10⁶ Pa, further preferably 5×10⁴ Pa to 1×10⁶ Pa. When the storage elastic modulus of the second pressure sensitive adhesive layer falls within the above-mentioned range, moderate adhesiveness is exhibited. In addition, fluidization of the second pressure sensitive adhesive is suppressed at the time when the optical film 10 and the front transparent member 70 are bonded to each other with the first pressure sensitive adhesive layer 21 interposed therebetween by heating, so that contamination of other members and the inside of the bonding device can be suppressed.

[Formation of Pressure Sensitive Adhesive Layer on Optical Film]

Examples of the method for forming the first pressure sensitive adhesive layer 21 and the second pressure sensitive adhesive layer 22 on the optical film 10 include a method in which the pressure sensitive adhesive composition is applied to a substrate such as a a release treated separator and dried to remove a solvent etc., and subjected to a crosslinking treatment as necessary to form a pressure sensitive adhesive layer, and the pressure sensitive adhesive layer is then transferred onto the optical film 10; and a method in which the pressure sensitive adhesive composition is applied to the optical film 10, and dried to remove a solvent etc., so that a pressure sensitive adhesive layer is formed on the optical film.

As the method for forming the pressure sensitive adhesive layer, various kinds of methods are used. Specific examples include roll coating, kiss roll coating, gravure coating, reverse coating, roll brushing, spray coating, dip roll coating, bar coating, knife coating, air knife coating, curtain coating, lip coating, and extrusion coating methods using a die coater etc. Among them, use of a die coater is preferred, and in particular, use of a die coater using a fountain die or a slot die is more preferred.

As a method for drying the applied pressure sensitive adhesive, a suitable method can be appropriately employed according to a purpose. The heating/drying temperature is preferably 40° C. to 200° C., more preferably 50° C. to 180° C., further preferably 70° C. to 170° C. The drying time is preferably 5 seconds to 20 minutes, more preferably 5 seconds to 15 minutes, further preferably 10 seconds to 10 minutes.

When the pressure sensitive adhesive composition includes a crosslinker, a heating for crosslinking may be performed after the pressure sensitive adhesive composition is applied on the substrate. The heating temperature and the heating time are appropriately set according to a type of crosslinker to be used, and crosslinking is normally performed by heating at 20° C. to 160° C. for 1 minute to about 7 days. Heating for drying the pressure sensitive adhesive after application may serve may also serve as heating for crosslinking.

Protective sheets 31 and 32 are releasably attached on the pressure sensitive adhesive layers 21 and 22, respectively, as necessary. The protective sheets are provided for protecting the exposed surfaces of the pressure sensitive adhesive layer, until the pressure sensitive adhesive is bonded to adherend. A substrate used for formation (application) of the pressure sensitive adhesive layer may be used as it is as a protective sheet.

As the protective sheets, a plastic film made of polyethylene, polypropylene, polyethylene terephthalate, polyester, and the like is preferably used. The thickness of each of the protective sheets 31 and 32 is normally 5 to 200 μm, preferably about 10 to 150 μm. The protective sheet may be subjected to release and antifouling treatments with a silicone-based, fluorine-based, long-chain alkyl-based or fatty acid amide-based releasing agent, a silica powder or the like, and an antistatic treatment of coating type, kneading type, vapor deposition type or the like. Particularly, by appropriately subjecting the surface of the protective sheet to a release treatment with using silicone, long-chain alkyl, fluorine or the like, releasability from the pressure sensitive adhesive layers can be further improved in practical use.

[Cutting of Optical Film with Pressure Sensitive Adhesive]

An optical film with a pressure sensitive adhesive is cut to a product size consistent with a sizeof an image display device (screen size). Examples of the cutting method include a method of punching the film using a Thompson blade etc., a method using a cutter such as a circular shear or a plate blade, laser light or hydraulic pressure.

(Curing of End Surface)

In the present invention, it is preferred that after the optical film with a pressure sensitive adhesive is cut to a predetermined size, a treatment for curing the end surface (end surface treatment) is performed for reducing the fluidity of the pressure sensitive adhesive 21e at the end surface of the first pressure sensitive adhesive layer 21. The curing method includes heat curing or photocuring as described above. Particularly, it is preferable to perform photocuring by applying an active ray such as an ultraviolet ray from the side surface of the optical film with a pressure sensitive adhesive.

When photocuring from the side surface is performed, it is preferable to adjust the intensity of applied light, the irradiation time and the like so that the width W₁ of the region where the fluidity of the pressure sensitive adhesive is low falls within the above-mentioned range. The optimum integrated irradiation amount varies depending on the composition of the pressure sensitive adhesive, etc., but it is, for example, about 50 mJ/cm² to 5000 mJ/cm².

Thus, in the optical film with a pressure sensitive adhesive in which the pressure sensitive adhesive 21e at the end surface of the first pressure sensitive adhesive layer 21 is cured, protrusion of the pressure sensitive adhesive is suppressed because the fluidity at the end surface is low. Since the pressure sensitive adhesive 21c at the in-plane central part maintains high fluidity even after curing of the pressure sensitive adhesive 21e at the end surface, generation of bubbles and occurrence of display unevenness in the vicinity of the printing level difference at the time of bonding the optical film to the front transparent member can be suppressed.

[Image Display Device]

The optical film with a pressure sensitive adhesive 55 is suitably used for formation of the image display device 100 which includes the front transparent member 70 such as a touch panel or a front transparent plate on one surface (viewing side) of the optical film 10 including a polarizing plate, and includes the image display cell 61 such as a liquid crystal cell or an organic EL cell on the other surface, as schematically shown in FIG. 2.

The front transparent member 70 is, for example, a front transparent plate (window layer) or a touch panel. As the front transparent plate, a transparent plate having appropriate mechanical strength and thickness. As this transparent plate, for example, a transparent resin plate such as that of an acryl-based resin or a polycarbonate-based resin, or a glass plate is used. As the touch panel, a touch panel of any type such as resistive film type, capacitance type, optical type or ultrasonic type is used.

In formation of the image display device, the method for bonding the image display cell 61 to the optical film with a pressure sensitive adhesive 55, and the method for bonding the front transparent member 70 to the optical film with a pressure sensitive adhesive 55 are not particularly limited, and bonding can be performed by various kinds of known methods after the protective sheets 31 and 32 attached on the surfaces of the first pressure sensitive adhesive layer 21 and the second pressure sensitive adhesive layer 22, respectively, are peeled off.

The order of bonding is not particularly limited, bonding of the image display cell 61 to the second pressure sensitive adhesive layer 22 of the optical film with pressure sensitive adhesive 55 may precede, or bonding of the front transparent member 70 to the first pressure sensitive adhesive layer 21 of the optical film with a pressure sensitive adhesive 55 may precede. The former bonding and the latter bonding may be performed in parallel. For improving workability in bonding and axis precision of the optical film, it is preferred that a cell-side bonding step of bonding the optical film 10 and the image display cell 61 to each other with the second pressure sensitive adhesive layer 22 interposed therebetween after peeling off the protective sheet 32 from the surface of the second pressure sensitive adhesive layer 22 is performed, followed by a viewing-side bonding step of peeling off the protective sheet 31 from the surface of the first pressure sensitive adhesive layer 21, and bonding the optical film 10 and the front transparent member 70 to each other with the first pressure sensitive adhesive layer 21 interposed therebetween.

It is preferred to perform degassing for removing bubbles at the interface between the first pressure sensitive adhesive layer 21 and the front transparent member 70, and in the vicinity of a non-flat portion such as the printed portion 76 on the front transparent member 70 after the optical film and the front transparent member are bonded to each other. As a degassing method, an appropriate method such as heating, pressurization or pressure reduction can be employed. For example, it is preferred that bonding is performed while ingress of bubbles is suppressed under reduced pressure and heating, and pressurization is then performed in parallel with heating through autoclave or the like for the purpose of, for example, suppressing delay bubbles.

When the pressure sensitive adhesive that forms the first pressure sensitive adhesive layer 21 is a curable pressure sensitive adhesive containing a curable compound, it is preferred to cure the first pressure sensitive adhesive layer (front curing step) after the optical film 10 and the front transparent member 70 are bonded to each other. By curing the first pressure sensitive adhesive layer, reliability of adhesion between the optical film 10 and the front transparent member 70 in the image display device can be improved. When the heating or pressurization is performed for the purpose of removing bubbles and the like after the optical film and the front transparent member are bonded to each other, it is preferred that curing of the first pressure sensitive adhesive layer is performed after removal of bubbles. By performing curing of the first pressure sensitive adhesive layer after removal of bubbles, generation of delay bubbles is suppressed.

The method for curing the first pressure sensitive adhesive layer is not particularly limited. When photocuring is performed, a method is preferred in which an active ray such as an ultraviolet ray is applied through the front transparent member 70. When the front transparent member 70 has a non-transparent portion such as the printed portion 76, an active ray is not applied to immediately below the printed portion. Although radicals generated in a portion irradiated with light transfers to a portion which is not irradiated with light to proceed curing of the pressure sensitive adhesive to a certain degree, the pressure sensitive adhesive layer immediately below the printed portion generally tends to cause insufficient curing towards the end surface. On the other hand, in the present invention, the pressure sensitive adhesive 21e is cured by, for example, application of light from the end surface side before the optical film is bonded to the front transparent member, and therefore the pressure sensitive adhesive immediately below the printed portion can be prevented from being kept uncured. Accordingly, peeling etc. of the pressure sensitive adhesive immediately below the printed portion is suppressed, so that an image display device excellent in bonding reliability between the optical film 10 and the front transparent member 70 is obtained.

### EXAMPLES

The present invention will be described more specifically below by showing examples and comparative examples, but the present invention is not limited to these examples.

[Polarizing Plate]

In each of Examples and Comparative Examples, a polarizing plate was used as an optical film in which a transparent protective film laminated on each of both surfaces of a polarizer formed of a 25 μm-thick stretched polyvinyl alcohol film impregnated with iodine. The transparent protective film on one surface (image display cell side) of the polarizer was a 40 μm-thick acryl-based film, and the transparent protective film on the other surface (viewing side) was a 60 μm-thick triacetyl cellulose film.

[Preparation of Cell-Side Pressure Sensitive Adhesive Sheet]

### (Preparation of Base Polymer)

97 parts by weight of butyl acrylate (BA) and 3 parts by weight of acrylic acid (AA) as monomer components, 0.2 part by weight of azobisisobutyronitrile (AIBN) as a thermopolymerization initiator, and 233 parts by weight of ethyl acetate were put into a separable flask provided with a thermometer, a stirrer, a cooling tube and a nitrogen gas inlet. Nitrogen purge was performed for 1 hour while the mixture was stirred under nitrogen atmosphere at 23° C. Thereafter, the mixture was reacted at 60° C. for 5 hours to obtain an acryl-based base polymer having a weight average molecular weight (Mw) of 1100000.

(Preparation of Pressure Sensitive Adhesive Composition)

0.8 part by weight of trimethylolpropane tolylene diisocyanate (trade name “CORONATE L”, manufactured by Nippon Polyurethane Industry Co., Ltd.) as an isocyanate-based crosslinker and 0.1 part by weight of a silane coupling agent (trade name “KBM-403”, manufactured by Shin-Etsu Chemical Co., Ltd.) based on 100 parts by weight of the base polymer were added to the obtained acryl-based base polymer solution to prepare a pressure sensitive adhesive composition (hereinafter, this pressure sensitive adhesive composition (solution) is referred to as “pressure sensitive adhesive X”).

(Formation of Pressure Sensitive Adhesive Sheet and Crosslinking)

The above prepared pressure sensitive adhesive composition was applied on a 38 μm-thick separator (a polyethylene terephthalate film with a surface subjected to a release treatment) so as to have a thickness of 20 μm after drying, and dried at 100° C. for 3 minutes to remove the solvent to obtain a pressure sensitive adhesive sheet. Thereafter, heating was carried out at 50° C. for 48 hours to perform a crosslinking treatment (hereinafter, this pressure sensitive adhesive sheet is referred to as “pressure sensitive adhesive sheet X”).

[Preparation of Viewing-Side Pressure Sensitive Adhesive Sheet]

### <Pressure Sensitive Adhesive Sheet A>

### (Preparation of Base Polymer)

40 parts by weight of 2-ethylhexyl acrylate (2EHA), 40 parts by weight of isostearyl acrylate (ISA), 10 parts by weight of N-vinylpyrrolidone (NVP) and 10 parts by weight of 4-hydroxybutyl acrylate (4HBA) as monomer components, 0.2 part by weight of AIBN as a thermopolymerization initiator and 233 parts by weight of ethyl acetate were put into a separable flask provided with a thermometer, a stirrer, a cooling tube and a nitrogen gas inlet. Nitrogen purge was performed for 1 hour while the mixture was stirred under nitrogen atmosphere at 23° C. Thereafter, the mixture was reacted at 65° C. for 5 hours and then reacted at 70° C. for 2 hours to obtain an acryl-based base polymer solution.

(Preparation of Photocurable Pressure Sensitive Adhesive Composition)

The following components were added to the obtained acryl-based base polymer solution, based on 100 parts by weight of the base polymer: 7 parts by weight of polypropylene glycol (#700) diacrylate (trade name: NK ESTER APG-700 manufactured by SHIN-NAKAMURA CHEMICAL CO., LTD.) as a difunctional acrylate having an ether bond; 0.1 part by weight of a trimethylolpropane adduct of xylylene diisocyanate (trade name: TAKENATE D110N manufactured by Mitsui Chemicals, Incorporated) as an isocyanate-based crosslinker; and 0.1 part by weight of 2,2-dimethoxy-1,2-diphenylethane-1-one (trade name: IRGACURE 651 manufactured by BASF Ltd.) as a photopolymerization initiator. The mixture was uniformly mixed to prepare an ultraviolet ray-curable pressure sensitive adhesive composition (hereinafter, this pressure sensitive adhesive composition is referred to as “pressure sensitive adhesive A”).

(Preparation of Pressure Sensitive Adhesive Sheet)

The pressure sensitive adhesive A was applied onto a release-treated surface of a 75 μm-thick separator so as to have a thickness of 150 μm after drying, dried at 100° C. for 3 minutes to remove the solvent, and then crosslinked through an aging treatment in an atmosphere at 25° C. for 3 days to obtain a pressure sensitive adhesive sheet (hereinafter, this pressure sensitive adhesive sheet is referred to as “pressure sensitive adhesive sheet A”).

<Pressure Sensitive Adhesive Sheet B>

To a base polymer solution prepared in the same manner as in the preparation of the pressure sensitive adhesive A, 1 part by weight of 2-acryloyloxyethyl isocyanate (trade name: KARENZ AOI manufactured by Showa Denko K.K.) as an acryl monomer having an isocyanate group was added based on 100 parts by weight of the base polymer, The mixture was stirred at 50° C. for 24 hours, so that the hydroxy group of the base polymer and the isocyanate were bonded to each other to introduce a double bond into the base polymer. Thereafter, 0.05 part by weight of TAKENATE D110N; and 0.1 part by weight of IRGACURE 651 were added, and the mixture was uniformly mixed to prepare an ultraviolet ray-curable pressure sensitive adhesive (hereinafter, this pressure sensitive adhesive composition is referred to as “pressure sensitive adhesive B”). The pressure sensitive adhesive B was applied onto a separator, and the same procedure as in the case of the preparation of the pressure sensitive adhesive sheet A was carried out to obtain a pressure sensitive adhesive sheet.

<Pressure Sensitive Adhesive Sheet C>

### (Preparation of Base Polymer)

60 parts by weight of 2EHA, 10 parts by weight of methyl methacrylate (MMA), 15 parts by weight of NVP and 15 parts by weight of hydroxybutyl acrylate (4HBA) as monomer components, 0.2 part by weight of AIBN) and 233 parts by weight of ethyl acetate were put into a separable flask provided with a thermometer, a stirrer, a cooling tube and a nitrogen gas inlet. Nitrogen purge was performed for 1 hour while the mixture was stirred under nitrogen atmosphere at 23° C. Thereafter, the mixture was reacted at 65° C. for 5 hours and then reacted at 70° C. for 2 hours to obtain an acryl-based base polymer solution.

(Preparation of Photocurable Pressure Sensitive Adhesive and Preparation of Pressure Sensitive Adhesive Sheet)

The following components were added to the obtained acryl-based base polymer solution, based on 100 parts by weight of the base polymer: 13 parts by weight of NK ESTER APG-700; 0.2 part by weight of TAKENATE D110N; and 0.1 part by weight of IRGACURE 651. The mixture was then uniformly mixed to prepare an ultraviolet ray-curable pressure sensitive adhesive (hereinafter, this pressure sensitive adhesive composition is referred to as “pressure sensitive adhesive C”). The pressure sensitive adhesive C was applied onto a separator, and the same procedure as in the case of the preparation of the pressure sensitive adhesive sheet A was carried out to obtain a pressure sensitive adhesive sheet.

<Pressure Sensitive Adhesive Sheet D>

To a base polymer solution prepared in the same manner as in the preparation of the pressure sensitive adhesive C, 1 part by weight of KARENZ AOI was added based on 100 parts by weight of the base polymer, and the mixture was stirred at 50° C. for 24 hours, so that the hydroxy group of the base polymer and the isocyanate of KARENZ AOI were bonded to each other to introduce a double bond into the base polymer. Thereafter, 0.05 part by weight of TAKENATE D110N; and 0.1 part by weight of IRGACURE 651 were added, and the mixture was uniformly mixed to prepare an ultraviolet ray-curable pressure sensitive adhesive (hereinafter, this pressure sensitive adhesive composition is referred to as “pressure sensitive adhesive D”). The pressure sensitive adhesive D was applied onto a separator, and the same procedure as in the case of the pressure sensitive adhesive sheet A was carried out to obtain a pressure sensitive adhesive sheet.

<Pressure Sensitive Adhesive Sheet E>

To a base polymer solution prepared in the same manner as in the preparation of the pressure sensitive adhesive C, 0.1 part by weight of TAKENATE D110N was added based on 100 parts by weight of the base polymer was added, and the mixture was uniformly mixed to prepare a pressure sensitive adhesive composition (hereinafter, this pressure sensitive adhesive composition is referred to as “pressure sensitive adhesive E”). The pressure sensitive adhesive E was applied onto a separator, and the same procedure as in the case of the pressure sensitive adhesive sheet A was carried out to obtain a pressure sensitive adhesive sheet.

<Pressure Sensitive Adhesive Sheets F and G>

The addition amount of TAKENATE D110N based on 100 parts by weight of the base polymer was changed to 0.2 part by weight (pressure sensitive adhesive F) and 0.3 part by weight (pressure sensitive adhesive G). Except that the above-mentioned change was made, the same procedure as in preparation of the pressure sensitive adhesive composition E was carried out to prepare pressure sensitive adhesive compositions (the prepared pressure sensitive adhesive compositions are referred to as “pressure sensitive adhesive F” and “pressure sensitive adhesive G”, respectively) and form pressure sensitive adhesive sheets.

### Example 1

### Preparation of A Polarizing Plate with Pressure Sensitive Adhesive

The pressure sensitive adhesive sheet X was bonded to one surface of the polarizing plate as a cell-side pressure sensitive adhesive layer. Thereafter, the pressure sensitive adhesive sheet A was bonded to the other surface of the polarizing plate as a viewing-side pressure sensitive adhesive layer. In this way, a polarizing plate with a pressure sensitive adhesive on both sides with a pressure sensitive adhesive sheet X having a thickness of 20 μm bonded to one surface of a polarizing plate, a pressure sensitive adhesive sheet A having a thickness of 150 μm bonded to the other surface, and a separator releasably attached on each of the pressure sensitive adhesive layers was obtained. The polarizing plate with a pressure sensitive adhesive on both sides was punched to a size of 50 mm×80 mm with a Thompson blade. 50 polarizing plates with a pressure sensitive adhesive on both sides after punching were stacked, and using a handy-type UV lamp (energy density of UVA: 300 mW/cm²), an ultraviolet ray with an integrated light amount of about 1000 mJ/cm² was applied from the side surface of the polarizing plate to cure the pressure sensitive adhesive at the end surface of the viewing-side pressure sensitive adhesive layer.

<Preparation of Image Display Device>

A backlight was removed from a replacement upper liquid crystal panel of Nintendo 3DS, a polarizing plate on a side opposite to the backlight side of the liquid crystal panel was removed from a liquid crystal cell, and a pressure sensitive adhesive on the cell surface was then removed using a clean cloth impregnated with ethanol. A separator on a cell-side pressure sensitive adhesive sheet of an optical film with a pressure sensitive adhesive on both sides was peeled off, and the cell-side pressure sensitive adhesive sheet surface was superimposed on the central part of the cell surface, and pressed with a hand roller to bond the optical film and the cell to each other.

Thereafter, the separator on the viewing-side pressure sensitive adhesive sheet was peeled off, a printed surface of a glass plate (0.7 mm×50 mm×80 mm), the peripheral edge of which was printed with a black ink in the form of a frame (ink printing thickness: 15 μm; ink printing width on each of both short sides (long side direction): 15 mm, ink printing width on each of both long sides (short side direction): 5 mm), was placed on an exposed surface of the pressure sensitive adhesive. The optical film and the glass plate were bonded to each other by a vacuum thermocompression bonding device (temperature: 25° C.; pressure in device: 50 Pa; pressure: 0.3 MPa; pressure retention time: 10 seconds). Thereafter, an autoclave treatment was performed (50° C., 0.5 MPa, 15 minutes). After the autoclave treatment, an ultraviolet ray with an integrated light amount of 3000 mJ/cm² was applied through the viewing-side glass plate using a high-pressure mercury lamp (10 mW/cm²), so that the photocurable pressure sensitive adhesive was cured. The obtained panel for evaluation was replaced by an image display panel of the main body of Nintendo 3DS, and electrical connection was performed to prepare an image display device for evaluation.

### Examples 2 to 4

Except that pressure sensitive adhesive sheets B to D were used as the viewing-side pressure sensitive adhesive layer, the same procedure as in Example 1 was carried out to prepare a polarizing plate with a pressure sensitive adhesive on both sides, and the same procedure as in Example 1 was carried out to prepare an image display device.

### Comparative Examples 1 to 3

Except that pressure sensitive adhesive sheets E to G were used as the viewing-side pressure sensitive adhesive layer, curing of the pressure sensitive adhesive at the end surface after punching was not performed, and curing with an ultraviolet ray after the autoclave treatment was not performed, the same procedure as in Example 1 was carried out to prepare a polarizing plate with a pressure sensitive adhesive on both sides and prepare an image display device.

### Comparative Examples 4 and 5

Except that pressure sensitive adhesive sheets A and C were used as the viewing-side pressure sensitive adhesive layer, and curing of the pressure sensitive adhesive at the end surface after punching was not performed, the same procedure as in Example 1 was carried out to prepare a polarizing plate with a pressure sensitive adhesive on both sides, and the same procedure as in Example 1 was carried out to prepare an image display device.

[Evaluation]

### <Gel Fraction of Pressure Sensitive Adhesive>

For measurement of the gel fraction of the pressure sensitive adhesive at the in-plane central part of the polarizing plate with a pressure sensitive adhesive on both sides, the in-plane central part of the polarizing plate was cut to a size of 40 mm×40 mm, the separator was peeled off, and 1 to 2 g of the pressure sensitive adhesive thus exposed to the surface was collected, and used as a sample. For measurement of the gel fraction of the pressure sensitive adhesive at the end surface of the polarizing plate with a pressure sensitive adhesive on both sides, 1 to 2 g of the pressure sensitive adhesive scraped off the end surface (within the range of 0.2 mm) of the pressure sensitive adhesive layer, and collected was used as a sample. For measurement of the gel fraction of the pressure sensitive adhesive of the image display device, the front transparent plate was peeled off from the image display device, and 1 to 2 g of the pressure sensitive adhesive thus exposed to the surface was collected from the in-plane central part, and used as a sample.

The sample was wrapped in a porous polytetrafluoroethylene film (manufactured by Nitto Denko Corporation; trade name: “NTF-1122”; thickness: 85 μm) cut to a size of 100 mm×100 mm, and the wrapped opening was tied with a kite string (1.5 mm (thickness)×100 mm (length)). The total weight (A) of the porous polytetrafluoroethylene film and the kite string measured beforehand was subtracted from the weight of this sample to calculate the weight (B) of the pressure sensitive adhesive sample. The pressure sensitive adhesive sample wrapped in the porous polytetrafluoroethylene film was immersed in approximately 50 mL of ethyl acetate at 23° C. for 7 days to elute sol components of the pressure sensitive adhesive to the outside of the polytetrafluoroethylene film. After immersion, the pressure sensitive adhesive wrapped in the porous polytetrafluoroethylene film was taken out, dried at 130° C. for 2 hours, and allowed to cool for about 20 minutes, and the dry weight (C) was measured. The gel fraction of the pressure sensitive adhesive was calculated from the following formula.

gel fraction (%)=100×(C−A)/B

### <Storage Elastic Modulus of Pressure Sensitive Adhesive Sheet>

A laminate of plurality of pressure sensitive adhesive sheet having a thickness of about 1.5 mm was used as a measurement sample. A dynamic viscoelasticity was measured under the following conditions using “Advanced Rheometric Expansion System (ARES)” manufactured by Rheometric Scientific, Inc., and a storage elastic modulus at 25° C. was read from the measurement results.

### (Measurement Conditions)

Deformation mode: torsion

Measurement Frequency: 1 Hz

Temperature elevation rate: 5° C./minute

Measurement temperature: −50 to 150° C.

Shape: parallel plate (8.0 mmφ)

<Residual Stress of Pressure Sensitive Adhesive Sheet>

A sheet piece of 40 mm×40 mm was cut out from the pressure sensitive adhesive sheet, rounded in the form of a column, and used as a measurement sample. In a tension tester, the chuck-to-chuck distance was adjusted to 20 mm, the measurement sample was set, and stretched to a strain of 300% (chuck-to-chuck distance: 80 mm) at a tension speed of 200 mm/minute and a measurement temperature of 25° C., and the stress (tensile stress) after elapse of 180 seconds with the chuck position being fixed was defined as a residual stress. For the pressure sensitive adhesives A to D, samples having different gel fractions were prepared by changing the amount of light applied to the pressure sensitive adhesive sheet, and a relationship between the gel fraction and the residual stress was plotted to perform linear approximation. The residual stress of the pressure sensitive adhesive at the end surface of the polarizing plate of each of Examples 1 to 4 was calculated from the obtained relational formula and the measured value of the gel fraction after curing of the end surface.

<Haze and Total Light Transmittance of Pressure Sensitive Adhesive Sheet>

Using a test piece with the pressure sensitive adhesive sheet bonded to a non-alkali glass (thickness: 0.8 to 1.0 mm; total light transmittance: 92%; haze: 0.4%), the haze and the total light transmittance were measured with a haze meter (manufactured by MURAKAMI COLOR RESEARCH LABORATORY CO., Ltd.; device name “HM-150”). A value obtained by subtracting the haze of the non-alkali glass (0.4%) from the measured value was defined as the haze of the pressure sensitive adhesive sheet. For the total light transmittance, the measured value was directly used. The pressure sensitive adhesive sheets A to G and X each had a haze within a range of 0.4% to 0.5%, and a total light transmittance of 92%.

<Protrusion of Pressure Sensitive Adhesive from End Surface>

The end surface of the optical film with a pressure sensitive adhesive on both sides was rubbed with a polyethylene terephthalate film, and presence/absence of the pressure sensitive adhesive deposited on the surface of the polyethylene terephthalate film was visually checked. Samples for which pressure sensitive adhesive contamination was not observed were rated “good”, and samples for which pressure sensitive adhesive contamination was observed were rated “bad”.

<Display Unevenness in Image Display Device>

Whether or not display unevenness occurred in the vicinity of the printed frame on the peripheral edge was visually checked while the panel of the image display device for evaluation was made to provide black-and-white display. Samples for which display unevenness did not occur were rated “good”, and samples for which display unevenness occurred were rated “bad”.

[Evaluation Results]

For Examples and Comparative Examples described above, the composition and properties of the pressure sensitive adhesive in the viewing-side pressure sensitive adhesive layer of the polarizing plate with a pressure sensitive adhesive on both sides; whether or not the end surface was cured (UV was applied from the side surface) during preparation of the optical film with a pressure sensitive adhesive on both sides; the gel fractions of the viewing-side pressure sensitive adhesive at the central part and the end; the residual stresses of the viewing-side pressure sensitive adhesive at the central part and the end; the storage elastic modulus of the viewing-side pressure sensitive adhesive at the central part; the results of evaluation on protrusion of the pressure sensitive adhesive from the end (pressure sensitive adhesive contamination); whether or not display unevenness occurred in the image display device; and the results of evaluation of the gel fraction, residual stress and storage elastic modulus at the central part of the viewing-side pressure sensitive adhesive in the image display device (after curing by application of an ultraviolet ray for Examples 1 to 4 and Comparative Examples 4 and 5) are shown in Table 1.

In Table 1, each of the components is described by abbreviation indicated below.

2EHA: 2-ethylhexyl acrylate
ISA: isostearyl acrylate
MMA: methyl methacrylate
NVP: N-vinylpyrrolidone
4HBA: 4-hydroxybutyl acrylate
HEA: hydroxyethyl acrylate
Irg651: IRGACURE 651

TABLE 1

| | | | Example 1 | Example 2 | Example 3 | Example 4 |
|---|---|---|---|---|---|---|
| Composition | Pressure sensitive adhesive sheet | | A | B | C | D |
| of | Base polymer | 2EHA | 40 | 40 | 60 | 60 |
| pressure | | ISA | 40 | 40 | — | — |
| sensitive | | MMA | — | — | 10 | 10 |
| adhesive | | NVP | 10 | 10 | 15 | 15 |
| | | 4HBA | 10 | 10 | — | — |
| | | HEA | — | — | 15 | 15 |
| | Crosslinker | TAKENATE D110N | 0.1 | 0.05 | 0.2 | 0.05 |
| | Radical-polymerizable | APG-700 | — | — | 13 | — |
| | compound | KARENZ AOI | — | 1 | — | 1 |
| | Photopolymerization | Irg651 | 0.1 | 0.1 | 0.1 | 0.1 |
| | initiator | | | | | |
| Polarizing | End surface curing treatment | | Done | Done | Done | Done |
| plate | Gel fraction of pressure | Central part | 50 | 43 | 40 | 42 |
| | sensitive adhesive (%) | End | 60 | 75 | 60 | 75 |
| | Residual stress | Central part | 1.0 | 1.6 | 1.5 | 4.5 |
| | (N/cm²) | End | 2.1 | 4.9 | 5.6 | 9.1 |

| | | | | | |
|---|---|---|---|---|---|
| | Storage elastic modulus of pressure sensitive adhesive | 4.5 | 7.3 | 8.6 | 28 |
| | (×10⁴ Pa) | | | | |
| | Glue protrusion | good | good | good | good |
| Image | Display unevenness | good | good | good | good |
| display | Gel fraction of pressure sensitive adhesive (%) | 65 | 86 | 65 | 88 |
| device | Residual stress of pressure sensitive adhesive (N/cm²) | 2.5 | 7.0 | 7.0 | 11 |
| | Storage elastic modulus of pressure sensitive adhesive | 11 | 9.3 | 27 | 31 |
| | (×10⁴ Pa) | | | | |

| | | | Comparative | Comparative | Comparative | Comparative | Comparative |
|---|---|---|---|---|---|---|---|
| | | | Example 1 | Example 2 | Example 3 | Example 4 | Example 5 |
| Composition | Pressure sensitive adhesive sheet | | E | F | G | A | C |
| of | Base polymer | 2EHA | 60 | 60 | 60 | 40 | 60 |
| pressure | | ISA | — | — | — | 40 | — |
| sensitive | | MMA | 10 | 10 | 10 | — | 10 |
| adhesive | | NVP | 15 | 15 | 15 | 10 | 15 |
| | | 4HBA | — | — | — | 10 | — |
| | | HEA | 15 | 15 | 15 | — | 15 |
| | Crosslinker | TAKENATE D110N | 0.1 | 0.2 | 0.3 | 0.1 | 0.2 |
| | Radical-polymerizable | APG-700 | — | — | — | 7 | 13 |
| | compound | KARENZ AOI | — | — | — | — | — |
| | Photopolymerization | Irg651 | — | — | — | 0.1 | 0.1 |
| | initiator | | | | | | |
| Polarizing | End surface curing treatment | | Not done | Not done | Not done | Not done | Not done |
| plate | Gel fraction of pressure | Central part | 38 | 57 | 78 | 50 | 40 |
| | sensitive adhesive (%) | End | | | | | |
| | Residual stress | Central part | 3.8 | 6.3 | 7.7 | 1.0 | 1.5 |
| | (N/cm²) | End | | | | | |

| | | | | | | |
|---|---|---|---|---|---|---|
| | Storage elastic modulus of pressure sensitive adhesive | 28 | 30 | 31 | 4.5 | 8.6 |
| | (×10⁴ Pa) | | | | | |
| | Glue protrusion | bad | good | good | bad | bad |
| Image | Display unevenness | good | bad | bad | good | good |
| display | Gel fraction of pressure sensitive adhesive (%) | 38 | 57 | 78 | 65 | 65 |
| device | Residual stress of pressure sensitive adhesive (N/cm²) | 3.8 | 6.3 | 7.7 | 2.5 | 7.0 |
| | Storage elastic modulus of pressure sensitive adhesive | 28 | 30 | 31 | 11 | 27 |
| | (×10⁴ Pa) | | | | | |

As shown in Table 1, it is apparent that in Examples 1 to 4, the end surface of the pressure sensitive adhesive sheet is cured by application of light from the side surface, resulting in a high gel fraction, and therefore the pressure sensitive adhesive does not protrude from the end surface. Further, it is apparent that since bonding is performed without curing the pressure sensitive adhesive layer at the in-plane central part, occurrence of display unevenness at the peripheral edge of the screen (in the vicinity of the printed frame) of the image display device is suppressed.

In Comparative Examples 4 and 5, display unevenness was suppressed because pressure sensitive adhesives having the same composition as in Examples 1 and 3 were used. However, since curing of the end surface was not performed, the pressure sensitive adhesive protruded from the end surface.

In Comparative Examples 1 to 3, the gel fraction (crosslinking degree) was changed by changing the content of a crosslinker in the pressure sensitive adhesive. In Comparative Example 1, the pressure sensitive adhesive had a low gel fraction and high fluidity, and therefore display unevenness did not occur, but the pressure sensitive adhesive protruded from the end surface. On the other hand, in Comparative Examples 2 and 3, the pressure sensitive adhesive had a high gel fraction and low fluidity, and therefore protrusion of the pressure sensitive adhesive from the end surface was suppressed, but display unevenness occurred in the image display device.

From the results in Comparative Examples 1 to 5, it is apparent that when a pressure sensitive adhesive having a low gel fraction and high fluidity is used, display unevenness is suppressed, but the pressure sensitive adhesive protrudes from the end surface of the optical film with a pressure sensitive adhesive, and when a pressure sensitive adhesive having a high gel fraction and low fluidity is used, protrusion of the pressure sensitive adhesive from the end surface is suppressed, but display unevenness tends to occur. On the other hand, it is apparent that by performing curing of the end surface, the gel fraction of the pressure sensitive adhesive at the end surface is increased and thus protrusion of the pressure sensitive adhesive from the end surface can be suppressed, while occurrence of display unevenness is also suppressed.

What is claimed is:

1. An optical film with a pressure sensitive adhesive, which is to be disposed between a front transparent plate or a touch panel and an image display cell, wherein
the optical film with a pressure sensitive adhesive comprises: an optical film including a polarizing plate; a first pressure sensitive adhesive layer provided on first main surface of the optical film, which is to be bonded to a front transparent plate or a touch panel; and a second pressure sensitive adhesive layer provided on second main surface of the optical film, which is to be bonded to an image display cell,
the first pressure sensitive adhesive layer has a thickness of 30 μm or more, and in the first pressure sensitive adhesive layer, a fluidity of a pressure sensitive adhesive at an end surface is lower than a fluidity of the pressure sensitive adhesive at an in-plane central part.

2. The optical film with a pressure sensitive adhesive according to claim 1, wherein in the first pressure sensitive adhesive layer, a gel fraction of the pressure sensitive adhesive at the end surface is higher by 5% or more than a gel fraction of the pressure sensitive adhesive at the in-plane central part.

3. The optical film with a pressure sensitive adhesive according to claim 2, wherein in the first pressure sensitive adhesive layer, the gel fraction of the pressure sensitive adhesive at the end surface is 55% or more.

4. The optical film with a pressure sensitive adhesive according to claim 3, wherein in the first pressure sensitive adhesive layer, the gel fraction of the pressure sensitive adhesive at the in-plane central part is less than 55%.

5. The optical film with a pressure sensitive adhesive according to claim 1, wherein the pressure sensitive adhesive at the central part of the first pressure sensitive adhesive layer has a storage elastic modulus of 1×10⁴ Pa to 1×10⁶ Pa at 25° C.

6. The optical film with a pressure sensitive adhesive according to claim 1, wherein a pressure sensitive adhesive composition that forms the first pressure sensitive adhesive layer has an acryl-based base polymer content of 50% by weight or more based on a total amount of solid components, and
the acryl-based base polymer contains a hydroxy group-containing monomer unit as a monomer unit, and a content of the hydroxy group-containing monomer unit is 3 to 50% by weight based on a total amount of constituent monomer units.

7. The optical film with a pressure sensitive adhesive according to claim 1, wherein the first pressure sensitive adhesive layer has a haze of 1.0% or less and a total light transmittance of 90% or more.

8. The optical film with a pressure sensitive adhesive according to claim 1, wherein a pressure sensitive adhesive composition that forms the first pressure sensitive adhesive layer contains a radical-polymerizable compound having a carbon-carbon double bond, or the radical-polymerizable compound having a carbon-carbon double bond is chemically bonded to a base polymer of the pressure sensitive adhesive.

9. The optical film with a pressure sensitive adhesive according to claim 8, wherein the radical-polymerizable compound is a polyfunctional polymerizable compound having two or more polymerizable functional groups per molecule.

10. The optical film with a pressure sensitive adhesive according to claim 8, wherein the pressure sensitive adhesive composition that forms the first pressure sensitive adhesive layer further contains a photopolymerization initiator.

11. The optical film with a pressure sensitive adhesive according to claim 1, wherein a thickness of the second pressure sensitive adhesive layer is 30 μm or less.

12. A method for producing the optical film with a pressure sensitive adhesive according to claim 1, comprising in the order:
cutting the optical film with a pressure sensitive adhesive to a predetermined size after the first pressure sensitive adhesive layer and the second pressure sensitive adhesive layer are provided on the optical film; and
reducing the fluidity of the pressure sensitive adhesive at the end surface of the first pressure sensitive adhesive layer by applying an active ray from a side surface of the optical film with a pressure sensitive adhesive.

13. A method for producing an image display device, the image display device comprising: a front transparent plate or a touch panel; an optical film including a polarizing plate; and an image display cell, arranged in this order from a viewing side, wherein
the method comprising:
providing an optical film with a pressure sensitive on both sides which comprises an optical film, a first pressure sensitive adhesive layer provided on first main surface of the optical film, and a second pressure sensitive adhesive layer provided on second main surface of the optical film,
bonding the second main surface of the optical film and the image display cell to each other with the second pressure sensitive adhesive layer interposed therebetween; and
bonding the first main surface of the optical film and the front transparent plate or the touch panel to each other with the first pressure sensitive adhesive layer interposed therebetween, wherein
the optical film includes a polarizing film,
the first pressure sensitive adhesive layer has a thickness of 30 μm or more, and
before bonding the optical film and the front transparent plate or the touch panel to each other with the first pressure sensitive adhesive layer, a fluidity of a pressure sensitive adhesive at an end surface of the first pressure sensitive adhesive layer is lower than a fluidity of a pressure sensitive adhesive at an in-plane central part of the first pressure sensitive adhesive.

14. The method for producing an image display device according to claim 13, wherein
a pressure sensitive adhesive that forms the first pressure sensitive adhesive layer contains a radical-polymerizable compound having a carbon-carbon double bond, or the radical-polymerizable compound having a carbon-carbon double bond is chemically bonded to a base polymer of the pressure sensitive adhesive,
the pressure sensitive adhesive further contains a photopolymerization initiator, and wherein
after bonding the optical film and the front transparent plate or the touch panel each other with the first pressure sensitive adhesive layer, the first pressure sensitive adhesive layer is cured by applying an active ray from a front transparent plate or touch panel side.

15. The method for producing an image display device according to claim 14, wherein
before bonding the optical film and the front transparent plate or the touch panel to each other with the first pressure sensitive adhesive layer, end surface treating of the first pressure sensitive adhesive layer is performed by applying an active ray from a side surface of the optical film with a pressure sensitive adhesive to cure the pressure sensitive adhesive at the end surface of the first pressure sensitive adhesive layer, so that the fluidity of the pressure sensitive adhesive at the end surface is reduced.
